(19) United States
(12) Patent Application Publication
(10) Pub. No.: US 2026/0111680 A1
(43) Pub. Date: Apr. 23, 2026

(54) METHODS AND SYSTEMS FOR MANAGING FUNCTION CALLS BY A GENERATIVE LANGUAGE MODEL

(71) Applicant: Shopify Inc., Ottawa (CA)

(72) Inventors: Ates Göral, Toronto (CA); Cody Mazza-Anthony, Toronto (CA); Ben Lafferty, New York, NY (US); Joshua Zucker, Toronto (CA); Juho Mikko Haapoja, Toronto (CA); Charles Lee, San Francisco, CA (US); Felipe Bezerra Leusin de Amorim, Oakville (CA)

(21) Appl. No.: 19/012,223

(22) Filed: Jan. 7, 2025

Related U.S. Application Data
(60) Provisional application No. 63/710,418, filed on Oct. 22, 2024.

(51) Int. Cl. G06F 40/35; G06F 9/44

(52) U.S. Cl. CPC G06F 40/35; G06F 9/44

(57) ABSTRACT

Methods and systems for managing functions calls by a large language model are described. A generated message is received from a generative language model, based on an input message in an ongoing conversation, the generated message indicating a function call related to the input message. The function is executed using the function call. A function response is received from the executed function. An output message is provided to the ongoing conversation based on the function response, wherein the providing of the output message bypasses the generative language model.

### CROSS-REFERENCE TO RELATED APPLICATION

The present disclosure claims priority from U.S. provisional patent application no. 63/710,418, filed Oct. 22, 2024, entitled “METHODS AND SYSTEMS FOR MANAGING FUNCTION CALLING AT AN LLM”, which is hereby incorporated by reference in its entirety.

### FIELD

The present disclosure relates to machine learning and generative language models including large language models (LLMs), and, more particularly, to managing function calls by a generative language model such as an LLM.

### BACKGROUND

A large language model (LLM) is a deep learning algorithm that can process natural language to summarize, translate, predict and generate text and other content. A LLM may be trained to learn billions of parameters in order to model how words relate to each other in a textual sequence. Inputs to a LLM may be referred to as prompts. A prompt is a natural language input that includes instructions to cause the LLM to generate a desired output.

A client device may interact with an LLM by providing messages to and receiving messages from the LLM in a conversation session. In some examples, a LLM may generate messages that include function calls during the conversation session.

### SUMMARY

Function calling (also referred to as tool calling) is a technique that enables an LLM (or an LLM-based agent) to generate messages based on the results of data generated by functions that are not inherently part of the LLM's capabilities. In a typical implementation, the LLM is instructed in a prompt that it has access to a set of functions and may use them accordingly in order to respond to various input messages (e.g., task requests from a client). As such, when the LLM receives a message that requires the use of a function to generate a response, the LLM identifies the appropriate function to use based on the query and available function definitions. For example, if the LLM has been trained to produce messages including structured outputs such as JSON outputs, the LLM may generate a message including structured output containing the function name and necessary parameters, for example:
{tool_calls=[{name=get_average_weather, arguments={city “Toronto”, month=“November”}]}

This structured output may be parsed by another component of the system that invokes the appropriate function using the LLM-generated function name and arguments. The result of the function execution is then provided back to the LLM which uses the result to generate a final response that is outputted to the client device.

In the conventional approach to function calling, the response generated by the function is provided to the LLM, which in turn uses the response from the function to generate an output message to the client device. A drawback of this approach is that a response from the function might need to be in a certain format or structure (e.g., structured lines of code) in order to be accurately processed by downstream processes (e.g., the response from the function may be required as input arguments to a downstream process/function); the LLM may inadvertently alter the structure and/or format of the response from the function, which may negatively impact the ability of downstream processes to parse the function response. Even if the LLM could be instructed to leave the function response unchanged, there is still another drawback in that the LLM is prompted twice (first with the input message that causes the LLM to call a function, second to cause the LLM to generate the output message based on the response from the function), which may incur additional latency and/or resource consumption (e.g., exhaustion of tokens and/or compute resources).

In various examples, the present disclosure provides a technical solution that maintains the capability of an LLM to make function calls, but allows for an output message based on the function response to be provided to the client device by bypassing the LLM. In this way, an output message can be provided to the client device while avoiding the possibility that the LLM inadvertently alters the structure and/or format of the function response. Accordingly, the present disclosure provides a technical advantage in that the output is more accurate, thus preventing system errors (e.g., where the system attempts to execute code in a function response that had been inadvertently altered by the LLM). Higher accuracy in the output also avoids the need to prompt the LLM to repeat the task in the event of an error, thus saving computer resources both at the LLM and at the overall system.

Another technical advantage is that by enabling an output message to be provided based on the function response without requiring the output message to be generated by the LLM, computing resources (e.g., tokens, computation time, memory, etc.) can be saved. In examples where the function response is in a domain specific language that does not use natural human language (e.g., in a programming language), such a function response typically cannot be efficiently represented using tokens (which are typically designed to efficiently represent natural human language). An LLM must process input by processing tokens one by one in sequence, meaning significant LLM processing resources will be consumed to process the tokens representing the function response. Thus, a significant amount of processing power and memory can be saved if the function response containing a domain specific language does not need to be processed by the LLM in order to provide an output message to the client device.

Other advantages provided by the examples of the present disclosure will be apparent to one skilled in the art in the context of the detailed description.

In an example aspect, the present disclosure describes a computer-implemented method including: receiving, from a generative language model, a generated message based on an input message in an ongoing conversation, the generated message indicating a function call related to the input message; cause execution of a function using the function call; receiving a function response from the executed function; and providing an output message to the ongoing conversation based on the function response, wherein the providing of the output message bypasses the generative language model.

In an example of the preceding example method, the function response may bypass the generative language model.

In an example of any of the preceding example methods, the method may include: after receiving the function response, parsing the function response to identify at least a portion of the function response intended to bypass the generative language model, wherein the parsing is by a component other than the generative language model; wherein the output message may be provided based on at least the identified portion of the function response.

In an example of any of the preceding example methods, the method may include: maintaining a conversation history for the ongoing conversation; and adding a response placeholder to the conversation history to indicate receipt of the function response.

In an example of any of the preceding example methods, the method may include: maintaining a conversation history for the ongoing conversation; and adding a response summary to the conversation history, the response summary representing information contained in the function response.

In an example of the preceding example method, the response summary may be extracted from the function response.

In an example of a preceding example method, the method may include generating the response summary based on the function response.

In an example of any of the preceding example methods, the function response may include a portion in a first structured language other than natural human language, and the output message may be provided based on the portion in the first structured language in the function response.

In an example of the preceding example method, the output message may include a copy of the portion in the first structured language in the function response.

In an example of a preceding example method, providing the output message may include: processing the portion in the first structured language into a corresponding portion in a second structured language; and providing the output message using the portion in the second structured language.

In an example of a preceding example method, providing the output message may include: processing the portion in the first structured language to validate the portion in the first structured language; and providing the output message based on the validated portion in the first structured language.

In another example aspect, the present disclosure describes a computer system including at least one processor; and a computer readable medium storing instructions that, when executed by the at least one processor, cause the computer system to: receive, from a generative language model, a generated message based on an input message in an ongoing conversation, the generated message indicating a function call related to the input message; cause execution of a function using the function call; receive a function response from the executed function; and provide an output message to the ongoing conversation based on the function response, wherein the output message is provided by bypassing the generative language model.

In an example of the preceding example computer system, the function response may bypass the generative language model.

In an example of any of the preceding example computer systems, the instructions may further cause the computer system to: after receiving the function response, parse the function response to identify at least a portion of the function response intended to bypass the generative language model, wherein the parsing is by a component of the computer system other than the generative language model; wherein the output message may be provided based on at least the identified portion of the function response.

In an example of any of the preceding example computer systems, the instructions may further cause the computer system to: maintain a conversation history for the ongoing conversation; and add a response placeholder to the conversation history to indicate receipt of the function response.

In an example of any of the preceding example computer systems, the instructions may further cause the computer system to: maintain a conversation history for the ongoing conversation; and add a response summary to the conversation history, the response summary representing information contained in the function response.

In an example of any of the preceding example computer systems, the function response may include a portion in a first structured language other than natural human language, and the output message may be provided based on the portion in the first structured language in the function response.

In an example of the preceding example computer system, the instructions may further cause the computer system to provide the output message by: processing the portion in the first structured language into a corresponding portion in a second structured language; and providing the output message using the portion in the second structured language.

In an example of a preceding example computer system, the instructions may further cause the computer system to provide the output message by: processing the portion in the first structured language to validate the portion in the first structured language; and providing the output message based on the validated portion in the first structured language.

In another example aspect, the present disclosure describes a non-transitory computer-readable medium storing instructions that, when executed by at least one processor of a computer system, cause the computer system to: receive, from a generative language model, a generated message based on an input message in an ongoing conversation, the generated message indicating a function call related to the input message; cause execution of a function using the function call; receive a function response from the executed function; and provide an output message to the ongoing conversation based on the function response, wherein the output message is provided by bypassing the generative language model.

In some examples, the computer-readable medium may store instructions that, when executed by the processor of the computing system, cause the computing system to perform any of the example aspect of the methods described above.

In another example aspect, the present disclosure provides a computer program including processor-executable instructions that, when executed by a processor of a computing system, cause the computing system to perform any of the example aspect of the methods described above.

### BRIEF DESCRIPTION OF THE DRAWINGS

Reference will now be made, by way of example, to the accompanying drawings which show example embodiments of the present application, and in which:

FIG. 1A is a block diagram of a simplified convolutional neural network, which may be used in examples of the present disclosure;

FIG. 1B is a block diagram of a simplified transformer neural network, which may be used in examples of the present disclosure;

FIG. 2 is a block diagram of an example computing system, which may be used to implement examples of the present disclosure;

FIG. 3 is a block diagram of an example conversation engine having a function manager, in accordance with examples of the present disclosure;

FIG. 4 is a signalling diagram illustrating an example operation of the conversation engine and function manager, in accordance with examples of the present disclosure; and

FIG. 5 is a flowchart illustrating an example method for managing a function call by a generative language model, in accordance with examples of the present disclosure.

Similar reference numerals may have been used in different figures to denote similar components.

### DETAILED DESCRIPTION

In various examples, the present disclosure describes methods and systems for managing function calls by a generative language model, such as a large language model (LLM). In some examples, the present disclosure provides a function manager that serves as an intermediary between the LLM and the called function. The function manager parses the response from the function and is responsible for providing the output message to the client device based on the function response. In this way, an output message based on the function response can be provided to the client device by bypassing the LLM.

While a generative language model, and more specifically an LLM, is discussed in examples of the present disclosure, it should be understood that other types of generative models that make function calls may benefit from aspects of the present disclosure. As such, the present disclosure is not necessarily limited to implementation with a generative language model or an LLM.

To assist in understanding the present disclosure, some concepts relevant to neural networks and machine learning (ML) are first discussed.

Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which need not be discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), and multilayer perceptrons (MLPs), among others.

DNNs are often used as ML-based models for modeling complex behaviors (e.g., human language, image recognition, object classification, etc.) in order to improve accuracy of outputs (e.g., more accurate predictions) such as, for example, as compared with models with fewer layers. In the present disclosure, the term “ML-based model” or more simply “ML model” may be understood to refer to a DNN. Training a ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model. For example, to train a ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. In another example, to train a ML model that is intended to classify images, the training dataset may be a collection of images. Training data may be annotated with ground truth labels (e.g. each data entry in the training dataset may be paired with a label), or may be unlabeled.

Training a ML model generally involves inputting into an ML model (e.g. an untrained ML model) training data to be processed by the ML model, processing the training data using the ML model, collecting the output generated by the ML model (e.g. based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or may be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training a ML model. Backpropagation is used to adjust (also referred to as update) the value of the parameters in the ML model, with the goal of optimizing the objective function. For example, a defined loss function is calculated by forward propagation of an input to obtain an output of the ML model and comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively, so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of a ML model typically involves further training the ML model on a number of data samples (which may be smaller in number/cardinality than those used to train the model initially) that closely target the specific task. For example, a ML model for generating natural language that has been trained generically on publicly-available text corpuses may be, e.g., fine-tuned by further training using the complete works of Shakespeare as training data samples (e.g., where the intended use of the ML model is generating a scene of a play or other textual content in the style of Shakespeare).

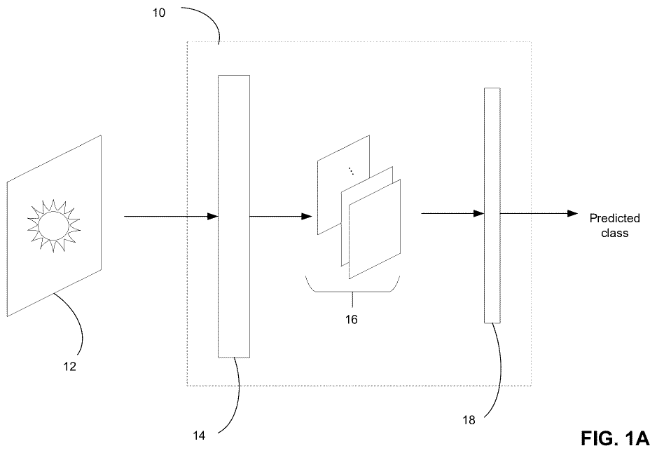

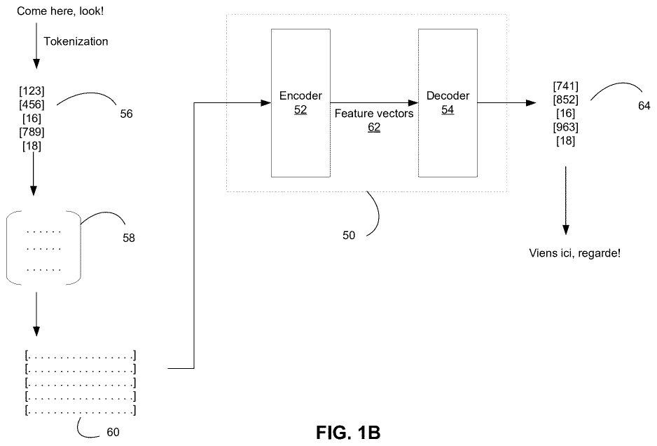

FIG. 1A is a simplified diagram of an example CNN 10, which is an example of a DNN that is commonly used for image processing tasks such as image classification, image analysis, object segmentation, etc. An input to the CNN 10 may be a 2D RGB image 12.

The CNN 10 includes a plurality of layers that process the image 12 in order to generate an output, such as a predicted classification or predicted label for the image 12. For simplicity, only a few layers of the CNN 10 are illustrated including at least one convolutional layer 14. The convolutional layer 14 performs convolution processing, which may involve computing a dot product between the input to the convolutional layer 14 and a convolution kernel. A convolutional kernel is typically a 2D matrix of learned parameters that is applied to the input in order to extract image features. Different convolutional kernels may be applied to extract different image information, such as shape information, color information, etc.

The output of the convolution layer 14 is a set of feature maps 16 (sometimes referred to as activation maps). Each feature map 16 generally has smaller width and height than the image 12. The set of feature maps 16 encode image features that may be processed by subsequent layers of the CNN 10, depending on the design and intended task for the CNN 10. In this example, a fully connected layer 18 processes the set of feature maps 16 in order to perform a classification of the image, based on the features encoded in the set of feature maps 16. The fully connected layer 18 contains learned parameters that, when applied to the set of feature maps 16, outputs a set of probabilities representing the likelihood that the image 12 belongs to each of a defined set of possible classes. The class having the highest probability may then be outputted as the predicted classification for the image 12.

In general, a CNN may have different numbers and different types of layers, such as multiple convolution layers, max-pooling layers and/or a fully connected layer, among others. The parameters of the CNN may be learned through training, using data having ground truth labels specific to the desired task (e.g., class labels if the CNN is being trained for a classification task, pixel masks if the CNN is being trained for a segmentation task, text annotations if the CNN is being trained for a captioning task, etc.), as discussed above.

Some concepts in ML-based language models are now discussed. It may be noted that, while the term “language model” has been commonly used to refer to a ML-based language model, there could exist non-ML language models. In the present disclosure, the term “language model” may be used as shorthand for ML-based language model (i.e., a language model that is implemented using a neural network or other ML architecture), unless stated otherwise. For example, unless stated otherwise, “language model” encompasses LLMs.

A language model may use a neural network (typically a DNN) to perform natural language processing (NLP) tasks such as language translation, image captioning, grammatical error correction, and language generation, among others. A language model may be trained to model how words relate to each other in a textual sequence, based on probabilities. A language model may contain hundreds of thousands of learned parameters or in the case of a large language model (LLM) may contain millions or billions of learned parameters or more.

In recent years, there has been interest in a type of neural network architecture, referred to as a transformer, for use as language models. For example, the Bidirectional Encoder Representations from Transformers (BERT) model, the Transformer-XL model and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

FIG. 1B is a simplified diagram of an example transformer 50, and a simplified discussion of its operation is now provided. The transformer 50 includes an encoder 52 (which may comprise one or more encoder layers/blocks connected in series) and a decoder 54 (which may comprise one or more decoder layers/blocks connected in series). Generally, the encoder 52 and the decoder 54 each include a plurality of neural network layers, at least one of which may be a self-attention layer. The parameters of the neural network layers may be referred to as the parameters of the language model.

The transformer 50 may be trained on a text corpus that is labelled (e.g., annotated to indicate verbs, nouns, etc.) or unlabelled. LLMs may be trained on a large unlabelled corpus. Some LLMs may be trained on a large multi-language, multi-domain corpus, to enable the model to be versatile at a variety of language-based tasks such as generative tasks (e.g., generating human-like natural language responses to natural language input).

An example of how the transformer 50 may process textual input data is now described. Input to a language model (whether transformer-based or otherwise) typically is in the form of natural language as may be parsed into tokens. It should be appreciated that the term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph, etc.) into a sequence of shorter segments that are converted to numerical representations referred to as tokens (or “compute tokens”). Typically, a token may be an integer that corresponds to the index of a text segment (e.g., a word) in a vocabulary dataset. Often, the vocabulary dataset is arranged by frequency of use. Commonly occurring text, such as punctuation, may have a lower vocabulary index in the dataset and thus be represented by a token having a smaller integer value than less commonly occurring text. Tokens frequently correspond to words, with or without whitespace appended. In some examples, a token may correspond to a portion of a word. For example, the word “lower” may be represented by a token for [low] and a second token for [er]. In another example, the text sequence “Come here, look!” may be parsed into the segments [Come], [here], [,], [look] and [!], each of which may be represented by a respective numerical token. In addition to tokens that are parsed from the textual sequence (e.g., tokens that correspond to words and punctuation), there may also be special tokens to encode non-textual information. For example, a [CLASS] token may be a special token that corresponds to a classification of the textual sequence (e.g., may classify the textual sequence as a poem, a list, a paragraph, etc.), a [EOT] token may be another special token that indicates the end of the textual sequence, other tokens may provide formatting information, etc.

In FIG. 1B, a short sequence of tokens 56 corresponding to the text sequence “Come here, look!” is illustrated as input to the transformer 50. Tokenization of the text sequence into the tokens 56 may be performed by some pre-processing tokenization module such as, for example, a byte pair encoding tokenizer (the “pre” referring to the tokenization occurring prior to the processing of the tokenized input by the LLM), which is not shown in FIG. 1B for simplicity. In general, the token sequence that is inputted to the transformer 50 may be of any length up to a maximum length defined based on the dimensions of the transformer 50 (e.g., such a limit may be 2048 tokens in some LLMs). Each token 56 in the token sequence is converted into an embedding vector 60 (also referred to simply as an embedding). An embedding 60 is a learned numerical representation (such as, for example, a vector) of a token that captures some semantic meaning of the text segment represented by the token 56. The embedding 60 represents the text segment corresponding to the token 56 in a way such that embeddings corresponding to semantically-related text are closer to each other in a vector space than embeddings corresponding to semantically-unrelated text. For example, assuming that the words “look”, “see”, and “cake” each correspond to, respectively, a “look” token, a “see” token, and a “cake” token when tokenized, the embedding 60 corresponding to the “look” token will be closer to another embedding corresponding to the “see” token in the vector space, as compared to the distance between the embedding 60 corresponding to the “look” token and another embedding corresponding to the “cake” token. The vector space may be defined by the dimensions and values of the embedding vectors. Various techniques may be used to convert a token 56 to an embedding 60. For example, another trained ML model may be used to convert the token 56 into an embedding 60. In particular, another trained ML model may be used to convert the token 56 into an embedding 60 in a way that encodes additional information into the embedding 60 (e.g., a trained ML model may encode positional information about the position of the token 56 in the text sequence into the embedding 60). In some examples, the numerical value of the token 56 may be used to look up the corresponding embedding in an embedding matrix 58 (which may be learned during training of the transformer 50).

The generated embeddings 60 are input into the encoder 52. The encoder 52 serves to encode the embeddings 60 into feature vectors 62 that represent the latent features of the embeddings 60. The encoder 52 may encode positional information (i.e., information about the sequence of the input) in the feature vectors 62. The feature vectors 62 may have very high dimensionality (e.g., on the order of thousands or tens of thousands), with each element in a feature vector 62 corresponding to a respective feature. The numerical weight of each element in a feature vector 62 represents the importance of the corresponding feature. The space of all possible feature vectors 62 that can be generated by the encoder 52 may be referred to as the latent space or feature space.

Conceptually, the decoder 54 is designed to map the features represented by the feature vectors 62 into meaningful output, which may depend on the task that was assigned to the transformer 50. For example, if the transformer 50 is used for a translation task, the decoder 54 may map the feature vectors 62 into text output in a target language different from the language of the original tokens 56. Generally, in a generative language model, the decoder 54 serves to decode the feature vectors 62 into a sequence of tokens. The decoder 54 may generate output tokens 64 one by one. Each output token 64 may be fed back as input to the decoder 54 in order to generate the next output token 64. By feeding back the generated output and applying self-attention, the decoder 54 is able to generate a sequence of output tokens 64 that has sequential meaning (e.g., the resulting output text sequence is understandable as a sentence and obeys grammatical rules). The decoder 54 may generate output tokens 64 until a special [EOT] token (indicating the end of the text) is generated. The resulting sequence of output tokens 64 may then be converted to a text sequence in post-processing. For example, each output token 64 may be an integer number that corresponds to a vocabulary index. By looking up the text segment using the vocabulary index, the text segment corresponding to each output token 64 can be retrieved, the text segments can be concatenated together and the final output text sequence (in this example, “Viens ici, regarde!”) can be obtained.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that may be considered to be an encoder-only language model. A decoder-only language model accepts embeddings as input and may use auto-regression to generate an output text sequence. Transformer-XL and GPT-type models may be language models that are considered to be decoder-only language models.

Because GPT-type language models tend to have a large number of parameters, these language models may be considered LLMs. An example GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2048 input tokens), and is able to generate a large number of tokens as output (e.g., up to 2048 tokens). GPT-3 has been trained as a generative model, meaning that it can process input text sequences to predictively generate a meaningful output text sequence. ChatGPT is built on top of a GPT-type LLM, and has been fine-tuned with training datasets based on text-based chats (e.g., chatbot conversations). ChatGPT is designed for processing natural language, receiving chat-like inputs and generating chat-like outputs.

A computing system may access a remote language model (e.g., a cloud-based language model), such as ChatGPT or GPT-3, via a software interface (e.g., an application programming interface (API)). Additionally or alternatively, such a remote language model may be accessed via a network such as, for example, the Internet. In some implementations such as, for example, potentially in the case of a cloud-based language model, a remote language model may be hosted by a computer system as may include a plurality of cooperating (e.g., cooperating via a network) computer systems such as may be in, for example, a distributed arrangement. Notably, a remote language model may employ a plurality of processors (e.g., hardware processors such as, for example, processors of cooperating computer systems). Indeed, processing of inputs by an LLM may be computationally expensive/may involve a large number of operations (e.g., many instructions may be executed/large data structures may be accessed from memory) and providing output in a required timeframe (e.g., real-time or near real-time) may require the use of a plurality of processors/cooperating computing devices as discussed above.

Inputs to an LLM may be referred to as a prompt, which is a natural language input that includes instructions to the LLM to generate a desired output. A computing system may generate a prompt that is provided as input to the LLM via its API. As described above, the prompt may optionally be processed or pre-processed into a token sequence prior to being provided as input to the LLM via its API. A prompt can include one or more examples of the desired output, which provides the LLM with additional information to enable the LLM to better generate output according to the desired output. Additionally or alternatively, the examples included in a prompt may provide inputs (e.g., example inputs) corresponding to/as may be expected to result in the desired outputs provided. A one-shot prompt refers to a prompt that includes one example, and a few-shot prompt refers to a prompt that includes multiple examples. A prompt that includes no examples may be referred to as a zero-shot prompt.

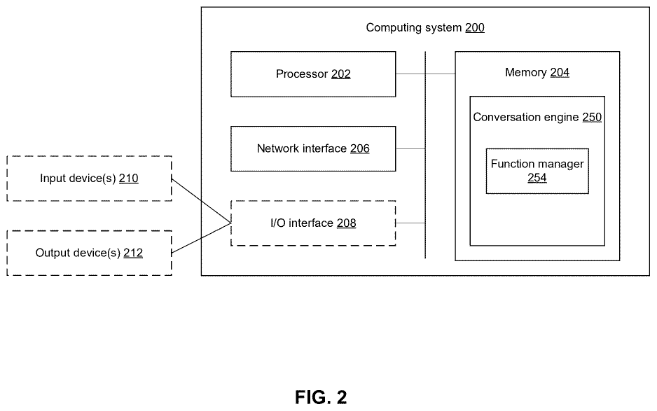

FIG. 2 illustrates an example computing system 200, which may be used to implement examples of the present disclosure. For example, the computing system 200 may be used to generate a prompt to an LLM to cause the LLM to generate output. Additionally or alternatively, one or more instances of the example computing system 200 may be employed to execute the LLM. For example, a plurality of instances of the example computing system 200 may cooperate to provide output using an LLM in manners as discussed above.

The example computing system 200 includes at least one processing unit and at least one physical memory 204. The processing unit may be a hardware processor 202 (simply referred to as processor 202). The processor 202 may be, for example, a central processing unit, a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof. The memory 204 may include a volatile or non-volatile memory (e.g., a flash memory, a random access memory (RAM), and/or a read-only memory (ROM)). The memory 204 may store instructions for execution by the processor 202, to cause the computing system 200 to carry out examples of the methods, functionalities, systems and modules disclosed herein.

The computing system 200 may also include at least one network interface 206 for wired and/or wireless communications with an external system and/or network (e.g., an intranet, the Internet, a P2P network, a WAN and/or a LAN). The network interface 206 may enable the computing system 200 to carry out communications (e.g., wireless communications) with systems external to the computing system 200, such as a LLM residing on a remote system.

The computing system 200 may optionally include at least one input/output (I/O) interface 208, which may interface with optional input device(s) 210 and/or optional output device(s) 212. Input device(s) 210 may include, for example, buttons, a microphone, a touchscreen, a keyboard, etc. Output device(s) 212 may include, for example, a display, a speaker, etc. In this example, optional input device(s) 210 and optional output device(s) 212 are shown external to the computing system 200. In other examples, one or more of the input device(s) 210 and/or output device(s) 212 may be an internal component of the computing system 200.

A computing system, such as the computing system 200 of FIG. 2, may access a remote system (e.g., a cloud-based system) to communicate with a remote language model or LLM hosted on the remote system such as, for example, using an application programming interface (API) call. The API call may include an API key to enable the computing system to be identified by the remote system. The API call may also include an identification of the language model or LLM to be accessed and/or parameters for adjusting outputs generated by the language model or LLM, such as, for example, one or more of a temperature parameter (which may control the amount of randomness or “creativity” of the generated output) (and/or, more generally some form of random seed as serves to introduce variability or variety into the output of the LLM), a minimum length of the output (e.g., a minimum of 10 tokens) and/or a maximum length of the output (e.g., a maximum of 1000 tokens), a frequency penalty parameter (e.g., a parameter which may lower the likelihood of subsequently outputting a word based on the number of times that word has already been output), a “best of” parameter (e.g., a parameter to control the number of times the model will use to generate output after being instructed to, e.g., produce several outputs based on slightly varied inputs). The prompt generated by the computing system is provided to the language model or LLM and the output (e.g., token sequence) generated by the language model or LLM is communicated back to the computing system. In other examples, the prompt may be provided directly to the language model or LLM without requiring an API call. For example, the prompt could be sent to a remote LLM via a network such as, for example, as or in message (e.g., in a payload of a message).

In the example of FIG. 2, the computing system 200 may store in the memory 204 computer-executable instructions, which may be executed by a processing unit such as the processor 202, to implement one or more embodiments disclosed herein. For example, the memory 204 may store instructions for implementing a conversation engine 250, which may include a function manager 254, as discussed further below.

In some examples, the computing system 200 may be a server of an online platform that provides the conversation engine 250 as a web-based or cloud-based service that may be accessible by a client device (also referred to as a client system, a client terminal, or simply a client), such as a user device, (e.g., via communications over a wireless network). Other such variations may be possible without departing from the subject matter of the present application.

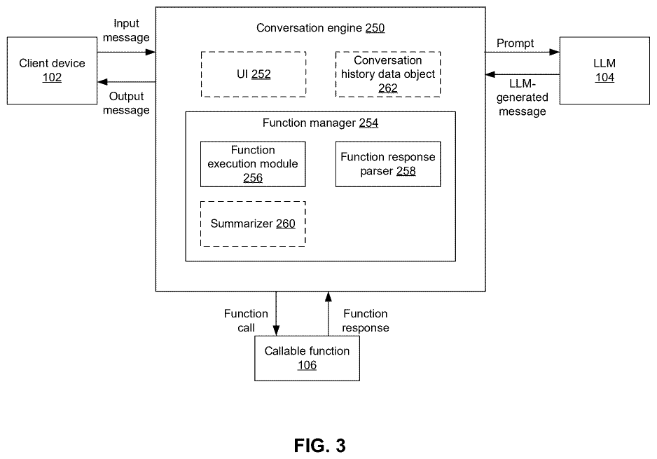

FIG. 3 is a block diagram illustrating details of an example conversation engine 250. The conversation engine 250 as disclosed herein may be used in various implementations, such as on a website, a portal, a software application, etc. In some examples, the disclosed conversation engine may be used to enable exchange of messages between a client and an LLM. In some examples, the client device may be a user device, and a human user may converse with an LLM-based agent (or chatbot) via the client device.

Although the conversation engine 250 is illustrated with certain modules, this is only exemplary and is not intended to be limiting. There may be greater or fewer numbers of modules in the conversation engine 250. Operations described as being performed by a particular module may be performed by a different module, or may be an overall function of the conversation engine 250, for example. The operations of the conversation engine 250 will be described in the context of an ongoing conversation session.

In the present disclosure, an ongoing conversation session may refer to a currently active session between a client device 102 (which may be any computing device, such as a smartphone, a desktop computer, a computing terminal, a laptop, etc.) and an LLM 104 (e.g., via the conversation engine 250). A conversation session may be an exchange of messages (e.g., system messages) between the client device 102 and the LLM 104. In some examples, a user may provide input messages and receive output messages in the conversation session via the client device 102, such as in examples where the user conducts a chat-based session with the LLM 104 via the client device 102. Some examples provided herein may be in the context of a chat-based session in which input messages to the LLM are natural language inputs via a chatbot UI, however this is not intended to be limiting. The conversation engine 250 may format an input message from the client device 102 into the form of a prompt to the LLM 104, and may receive an LLM-generated message in return. The LLM-generated message may be processed by the conversation engine 250, as disclosed herein, to provide an output message to the client device 102. In this way, the conversation engine 250 may enable a client device 102 to conduct an ongoing conversation with the LLM 104.

Although referred to and shown as an LLM 104, any suitable language model may be used (e.g., LLaMA, Falcon 40B, GPT-3, GPT-4, BART, etc.) and need not be limited to a large language model. Further, it should be understood that the language model may be a multi-modal language model (e.g., BLIP-2, CLIP, GPT-4V, etc.) that is capable of processing multi-modal inputs (e.g., inputs that include text, images, other media, and combinations thereof). Thus, it should be understood that the present disclosure is not intended to be limited to LLMs and is not intended to be limited to text-only messages.

In some examples, the LLM 104 may be hosted by a remote system external to the computing system 200 that implements the conversation engine 250. The conversation engine 250 may communicate with the LLM 104 by sending prompts via API calls, for example, and may receive messages generated by the LLM 104 in response.

In the example shown, the conversation engine 250 includes an optional UI 252, which may provide an interface for a user to, via the client device 102, provide input messages and view output messages in examples where the conversation session is a session that involves a user. For example, the UI 252 may provide an interface in the form of a virtual assistant for an application, a website or portal, among other applications. In some examples, the UI 252 may be configured to render user interface elements in the chat-based session. For example, the UI 252 may be capable of rendering UI elements (e.g., soft buttons, links, etc.) in the chat-based session.

The conversation engine 250 may also maintain an optional conversation history data object 262. The conversation history data object 262 may be used to store messages from the ongoing conversation session at least for the duration of the conversation session. In some examples, messages from the ongoing conversation session may be stored as conversation history by another component external to the conversation engine 250. As the conversation session is an ongoing conversation session, the conversation history data object 262 may increase in size (e.g., increase in the amount of memory required to store the conversation history, increase in the number of words or characters stored and/or increase in the number of messages stored) as messages are added to the conversation session. Thus, the conversation history data object 262 may not be a static data object. When a conversation session ends (e.g., by the client device 102 terminating the session, by a timeout, etc.), the conversation history data object 262 may or may not be stored for future use. The information (e.g., messages) stored in the conversation history data object 262 may be used to provide contextual information to the LLM 106 (e.g., a summary of, a selection of, or all of the messages in the conversation history data object 262 may be included in a prompt to the LLM 106), which may enable the LLM 106 to generate a response message that is more accurate and/or relevant to the ongoing conversation.

In this example, the conversation engine 250 includes a function manager 254. The function manager 254 may perform operations that manage function calls made by the LLM 104 (e.g., where a response message generated by the LLM 104 includes a function call) and that processes function responses in order to provide an output message to the client device 102.

The function manager 254 may make function calls to cause various callable functions to be executed (for simplicity, one callable function 106 is shown). A callable function 106 may be any function or tool accessible to (or callable by) the computing system 200, and may include both functions internal to the computing system 200 as well as functions provided by a remote system. For example, a callable function 106 may be another LLM (which may be referred to as a secondary LLM, to differentiate from the primary LLM 104 that primarily generates messages in the ongoing conversation). For example, a secondary LLM may be fine-tuned on specific data such as specialized knowledge or syntactically sensitive structured output such as a domain specific language (DSL). This DSL may be used by the UI 252 to render an interactable UI element, which when activated (e.g., by a user) may execute an action. The callable function 106 need not be another LLM or another language model, and can be any function (that may or may not use machine learning) that generates a function response. In particular, the callable function 106 may generate a function response having at least a portion that is intended to be directly outputted to the ongoing conversation (e.g., directly outputted via the UI 252). For example, the function response may include a portion that is not in natural human language (e.g., is in a DSL such as renderable code, navigation commands, etc.) that is intended to be directly outputted to the UI 252 in order to render a UI element.

The LLM 104 may be pre-trained, or informed in an initial prompt, to understand the functions it can call (e.g., including the appropriate format for calling a callable function 106 and the expected function response). In response to a prompt, the LLM 104 may generate a message that includes a function call. The conversation engine 250 receives the generated message and may identify the presence of a function call in the LLM-generated message. The conversation engine 250 may, as disclosed herein, use the function manager 254 to make a function call to the callable function 106 and receive a function response from the callable function 106; the function manager 254 may further perform operations to provide an output message to the client device 102 based on the function response, without requiring the function response to be provided to the LLM 104 (thus bypassing the LLM 104). In some examples, the function manager 254 may perform operations to add the function response to the conversation history data object 262. The function response that is added to the conversation history data object 262 in this way may be labeled as being a message from the callable function 106, or being identified in some other manner as originating from a system other than the LLM 104 or the client device 102 (e.g., labeled as originating from an “assistant” or secondary source). In some examples, the function manager 254 may perform further operations to add an indication of the function response (such as a response placeholder and/or a response summary) to the conversation history data object 262, so that the conversation history data object 262 accurately reflects the state of the ongoing conversation. The response placeholder and/or response summary may be added to the conversation history data object 262 instead of or in addition to adding the function response itself to the conversation history data object 262. Including the function response, the response placeholder and/or response summary in the conversation history data object 262 may be useful to provide more accurate contextual information to the LLM 104, for example when the conversation history data object 262 is subsequently used to provide contextual information in a prompt to the LLM 104.

In the example shown, the function manager 254 is a component of the conversation engine 250, however this is not intended to be limiting. In some examples, the function manager 254 may reside upstream of the LLM 104, for example in a service hosted on the same server as the LLM 104 or on a separate server in cases where the LLM 104 is hosted by a third-party server. In some examples, the function manager 254 may be positioned in an intermediary layer, such as positioned upstream of the client device 102 and downstream of any function executions. In some examples, such an intermediary layer may be a service hosted on a third-party server that is separate from the server hosting the LLM 104. In some examples, where making the function call comprises making an API call to a third-party server, the intermediary layer may be on the same server as the function execution. In some examples, the LLM 104 may be hosted on the client device 102 (e.g., an “on-premise” or “on-prem” LLM). In such cases, the function manager 254 may reside on the infrastructure of the client device 102 instead of on a cloud service or external server. It should be understood that the embodiments described herein are not limiting. Various modifications of the architecture described and shown herein, including configurations of the function manager 254 and its interactions with the LLM 104, may be made without deviation from the scope of the disclosure. For example, the function manager 254 may be integrated with other components or systems, or its functionality may be distributed across multiple servers in an architecture not explicitly detailed herein. The present disclosure is intended to encompass all such variations and adaptations.

In the example shown in FIG. 3, the function manager 254 includes a function execution module 256, a function response parser 258 and optionally a summarizer 260. The example shown is not intended to be limiting. It should be understood that there may be greater or fewer modules in the function manager 254. Operations described as being performed by a particular module may be performed by a different module, or may be an overall function of the function manager 254 or the conversation engine 250, for example.

The function manager 254 may process messages generated by the LLM 104 to identify and parse a function call in an LLM-generated message. The function manager 254 may use the function execution module 256 to make a function call to the appropriate callable function 106. The function response from the callable function 106 may be received by the function manager 254. In some examples, the function manager 254 may store information (e.g., a list of function identifiers) that identifies whether a callable function 106 is one whose function response should bypass the LLM 104. In some examples, a callable function 106 may announce itself as providing a function response that should bypass the LLM 104. If a callable function 106 is identified as a function whose function response should bypass the LLM 104, the function manager 254 may, after receiving the function response, automatically process the function response and provide an output message while the function response bypasses the LLM 104. In some examples, the function manager 254 may parse the function response (e.g., using the function response parser 258) in order to determine whether or not the function response should bypass the LLM 104. For example, a function response may include a tag that identifies a portion of the function response as being in a DSL, which may be a language other than natural human language (e.g., a portion of the function response may be marked by a tag such as <DSL begin>), in which case the function manager 254 may determine that at least the identified portion of the function response should bypass the LLM 104.

If the function manager 254 determines that no portion of the function response should bypass the LLM 104, the function response may be provided as input to the LLM 104 and the LLM 104 may use the function response to generate an output message to the client device 102.

If the function manager 254 determines that at least a portion of the function response should bypass the LLM 104, the function response parser 258 may be used to parse the function response to provide an output message to the client device 102 (e.g., via the UI 252). For example, the function response parser 258 may parse the function response to extract lines of code from the function response and provide the code directly to be rendered in the UI 252. In some examples, the function response parser 258 may identify and recognize specific labels, markers or tags that demarcate portion(s) of the function response that should be directly used to provide an output message (e.g., a portion of the function response demarcated by the tags <DSL begin> and <DSL end> may be extracted and directly used by the function manager 254 to provide an output message, bypassing the LLM 104). In some examples, the function response parser 258 may parse proprietary DSL to convert the DSL into a non-proprietary code (e.g., JSON) that can be rendered in the UI 252. In some examples, the function response parser 258 (or more generally the function manager 254) may include a buffer to store DSL from the function response as it is being received (e.g., in examples where the function response is received as a data stream), so that the DSL can be parsed as a block of code when it is complete.

In some examples, the function response parser 258 may perform operations to validate the DSL (e.g., validate the grammar and/or structure of the DSL). For example, the function response parser 258 may validate the functionality of the DSL by checking that the structure of the DSL matches a defined API specification (e.g., that the methods being called exist within the schema). In some examples, where the DSL is executable code, the function response parser 258 (or more generally the function manager 254) may attempt to execute the generated code and evaluate whether the execution is successful or results in an error. If an error is encountered, the function manager 254 may attempt another function call, may provide an output message indicating that an error was encountered and/or may provide information about the error to the LLM 104 to instruct the LLM 104 to generate a revised function call, among other possibilities. Notably, the present disclosure may enable the function manager 254 to receive and process the function response to check for errors instead of providing the function response to the LLM 104 (as is conventionally done), so that if there is an error in the function response the function manager 254 may take the appropriate action. This avoids an erroneous output from the called function from being processed by the LLM 104 and added to the conversation history, which can negatively impact the subsequent operation of the LLM 104 that makes use of the conversation history, as well as being a waste of computing resources at the LLM 104.

In some examples, the function manager 254 may, after receiving the function response, add a response placeholder in the conversation history data object 262, which may provide contextual information to the LLM 104 that the callable function 106 was successfully executed. This may be useful in examples where the LLM 104 has been configured (e.g., trained) to expect a function response for each function call. The response placeholder may be generic text indicating the function is complete (e.g., “The function is done”). In some examples, the response placeholder may be a lookup reference (or more generally a resource identifier, such as a universal resource identifier (URI)) that may be used to look up a text description that is more specific to the called function (e.g., the response placeholder may be an index value that is used to reference a look up table containing text specific to the called function, such as “An album is created” where the called function creates a photo album data object). It should be noted that the response placeholder may be added to the conversation history data object 262 any time after receiving the function response and before the conversation history data object 262 is subsequently used to provide contextual information to the LLM 104 (e.g., any time before a subsequent prompt to the LLM 104 within the same conversation session).

In some examples, the function manager 254 may, after receiving the function response, add a response summary in the conversation history data object 262. The response summary may serve a different purpose than the response placeholder in that the response summary in the conversation history data object 262 provides context to the LLM 104 about the information that the function response added to the ongoing conversation, thus enabling the LLM 104 to understand the current state of the conversation (e.g., “The album called Happy Birthday is created with 20 photos”); whereas the response placeholder may be simply an indicator to the LLM 104 that the function response was received. In some examples, the response summary and the response placeholder may have the same or overlapping text, or the response summary can be added to the conversation history data object 262 without adding the response placeholder (e.g., to avoid unnecessarily increasing the size of the conversation history data object 262). The response summary may be extracted from the function response (e.g., the function response parser 258 may recognize a label, tag or marker in the function response indicating text intended to be used as a response summary, and may extract this text to use as the response summary). In some examples, the function manager 254 may include a summarizer 260 (which may be a language model) that generates the response summary. In some examples, the function manager 254 may use a summarizer tool (such as another language model) external to the conversation engine 250 to obtain the response summary. Optionally, the response summary may be provided in an output message to the client device 102. The response summary may be provided to the client device 102 prior to providing the output message based on the function response (which may take longer to process by the function manager 254), which may reduce the perceived latency at the client device 102.

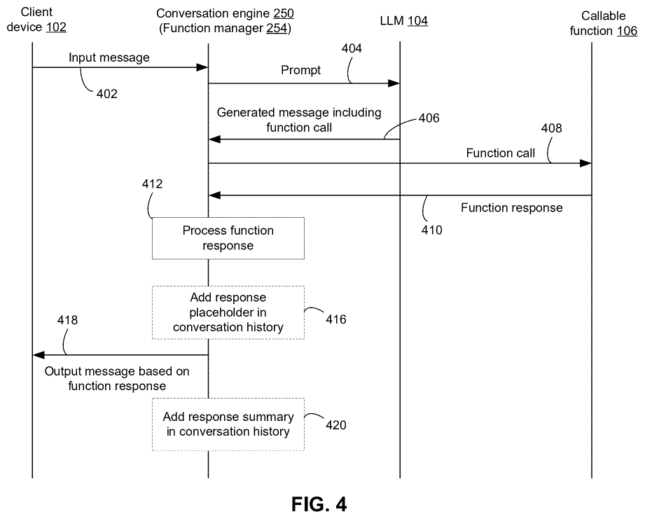

FIG. 4 is a signalling diagram illustrating example communications performed by the conversation engine 250 and in particular the function manager 254. FIG. 4 illustrates selected computing components discussed above, including the client device 102, the LLM 104, the conversation engine 250 (which includes the function manager 254 in this example) and the callable function 106. The signalling described below and shown in FIG. 3 are only exemplary and are not intended to be limiting.

In this example, at 402 an input message is sent by the client device 102 (e.g., via a UI). The input message may be received at the client device 102 in the form of text input or non-textual input (e.g., verbal input, touch input, etc.) that may be converted to text input. The input message may be a natural language message, which may be a task request (e.g., “I want to create an online photo album”). The input message is received at the conversation engine 250. The conversation engine 250 may add the input message to the conversation history data object 262.

At 404, the conversation engine 250 provides a prompt to the LLM 104 based on the input message. The LLM 140 processes the prompt and at 406 sends a generated message that includes a function call. The generated message is received by the conversation engine 250, and the conversation engine 250 may add the LLM-generated message to the conversation history data object 262. The conversation engine 250 may identify the presence of the function call in the generated message.

The conversation engine 250 may use the function manager 254 to parse the LLM-generated message to identify the appropriate function to call, and the appropriate argument for making the function call. At 408, the function manager sends a function call to the appropriate callable function 106. The callable function 106 executes and at 410 sends a function response to the conversation engine 250.

In this example, the function response includes at least a portion that is intended to be directly outputted (without processing by the LLM 104). An example function response is shown below:
<|preamble_begin|> Let's create a new album called Birthday!<|preamble_end|>
<|DSL-begin|>
forms fill: title “Birthday”
forms fill: description “Joe's 50th birthday”
<|DSL-end|>

In this example, the portion between the labels <|DSL_begin|> and <|DSL_end|> may be DSL (e.g., code) that is intended to be directly provided to the UI 252 (e.g., to be rendered in the UI 252).

At 412, the function manager 254 processes the function response. The following signals/operations 416, 418, 420 may be as a result of processing the function response, they may take place in parallel or in an order other than that shown.

Optionally, at 416, the function manager 254 adds a response placeholder to the conversation history data object 262. The response placeholder may replace the actual function response in the conversation history data object 262. The response placeholder may be generic or may be specific to the function response. Generally, inclusion of the response placeholder in the conversation history data object 262 may ensure that the conversation history data object 262 includes contextual information to inform the LLM 104 that a function call was successful.

At 418, the function manager 254 provides an output message based on the function response directly to client device 102 (e.g., via the UI), bypassing the LLM 104. The output message can be simply relaying a portion of or the entire function response. In some examples, the function manager 254 may perform operations on the function response to provide the output message, for example converting a proprietary DSL in the function response to non-proprietary code; validating the grammar/structure of DSL in the function response; adding formatting/structure to the function response; etc. The conversation engine 250 may add the output message to the conversation history data object 262.

Optionally, at 420 the function manager 254 provides (e.g., generates) a response summary and adds it to the conversation history data object 262. The response summary may be simply a preamble extracted from the function response (e.g., the portion between the labels <|preamble_begin|> and <|preamble_end|> in the example function response above). In some examples, the function manager 254 may call on another function to generate the response summary. In some examples, the conversation engine 250 can track whether a UI element outputted in the UI 252was actioned, and the response summary can be dependent on whether the output was actioned (e.g., whether or not the UI element in the output message was invoked at the client device 102).

In some examples, the client device 102 may perform operations to generate a summary or a copy of the output message that was received in response to the original input message, and provide the summary or copy of the output message to the conversation engine 250 (not shown in FIG. 4). The summary or copy of the output message from the client device 102 may provide a client-side version of the output message, which may or may not be identical to the output message provided by the function manager 254. For example, there may be other downstream processes that format or otherwise process the output message before finally being received by the client device 102. The client-side version of the output message may be added to the conversation history data object 262. The client-side version of the output message may be added to the conversation history data object 262 together with or replacing the function response, response placeholder and/or response summary. The client-side version of the output message may be labeled in the conversation history data object 262 as being the client-side version (e.g., labeled as “what the client received”). By enabling the client device 102 to communicate to the function manager 254 the client-side version of the output message and enabling the client-side version of the output message to be added to the conversation history data object 262, examples of the present disclosure may enable more contextual information to be provided in the conversation history data object 262.

As noted above, operations 416 and/or 420 may be optional. In some examples, only one of the operations 416, 420 may be performed (e.g., only a response placeholder or only a response summary is added to the conversation history data object 262). In some examples, both operations 416 and 420 may be performed (e.g., both a response placeholder and a response summary are added to the conversation history data object 262). Operations 416 and/or 420 may enable the conversation engine 250 to add information to the conversation history data object 262 without such information processed by the LLM 104 (e.g., a response placeholder and response summary can be directly added to the conversation history data object 262 rather than being inputted to the LLM 104). It should be noted that operations 416 and/or 420 need not be performed synchronously with receipt of the function response, but rather may be performed any time before the conversation history data object 262 is next used to prompt the LLM 104.

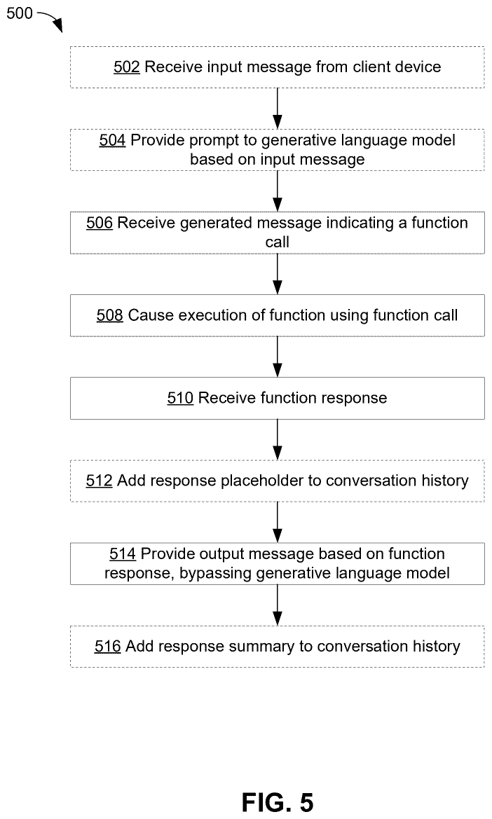

FIG. 5 is a flowchart of an example method 500 for an example embodiment of the present disclosure, which may be performed by a computing system, in accordance with examples of the present disclosure. For example, a processing unit of a computing system (e.g., the processor 202 of the computing system 200 of FIG. 2) may execute instructions (e.g., instructions of the conversation engine 250) to cause the computing system to carry out the example method 500. The method 500 may, for example, be implemented by an online platform or a server. The operations of the conversation engine 250 (and in particular the function manager 254) as described above may illustrate an example implementation of the method 500.

The method 500 may be performed during an ongoing conversation session. A conversation history for the ongoing conversation may be maintained (e.g., stored as a conversation history data object 262) and added to as messages are added to the conversation session.

The method 500 may optionally include an operation 502 in which an input message in an ongoing conversation session is received from the client device 102 (e.g., via the UI 252). The input message may be in natural human language, for example, and may include a request to perform a task. In some examples, the input message may be a system message from the client device 102. In some examples, the method 500 may be performed after receiving the input message.

The method 500 may optionally include an operation 504 in which a prompt is provided to a generative language model (e.g., the LLM 104) based on the input message. In some examples, the method 500 may be performed after the prompt has been provided.

At an operation 506, a generated message is received from the generative language model (e.g., the LLM 104) based on the input message in the ongoing conversation session. The generated message indicates (e.g., includes) a function call related to the input message (e.g., a function call to execute a function that performs a task requested in the input message).

At an operation 508, a function is caused to be executed using the function call. As described above, the generated message may be parsed to identify the function and arguments for making the function call. The operation 508 may be performed by executing the function by the computer system 200 (e.g., making a call to an internal function of the computer system 200) or by causing a remote function to be executed (e.g., making a call to a remote function). At 510, a function response is received from the executed function.

Optionally, at an operation 512, a response placeholder may be added to the conversation history (e.g., added to the conversation history data object 262) to indicate receipt of the function response. A response placeholder may be generic text indicating a function response was received, for example. In some examples, a response placeholder may be a lookup reference that may be used by the generative language model (or other system component) to look up a more descriptive text about the function response.

At an operation 514, an output message is provided to the ongoing conversation (e.g., via the UI 252) based on the function response. Notably, the output message is provided while bypassing the generative language model. This means that the generative language model need not process the function response in order for an output message based on the function response to be provided to the ongoing conversation. As previously discussed, this provides multiple technical advantages such as ensuring that the format and/or structure of the function response is not inadvertently changed by the generate language model, as well as saving computing resources that would otherwise be consumed by the generative language model.

In some examples, the function response may entirely bypass the generative language model. That is, no portion of the function response is processed by the generative language model (except to the extent that any portion of the function response is used as a response summary in the conversation history).

In some examples, the output message may be based on only a portion of the function response. For example, the function manage 254 may parse the function response to identify a portion of the function response intended to bypass the generative language model (e.g., as denoted by tags, labels, markers, etc.) and use that identified portion to provide the output message to the client device 102. Notably, the parsing of the function response to identify the portion of the function response is performed by a system component other than the generative language model (e.g., is performed by the function response parser 258 of the function manager 254).

In some examples, the output message may be provided based on a portion of the function response that is in a structured language (e.g., a DSL such as a programming language) other than natural human language. For example, the function manager 254 may include a copy of the portion in the structured language in the output message (e.g., copy the DSL directly into the output message without changing the structure and/or format). In some examples, the function manager 254 may perform some processing on the structured language in the function response in order to provide the output message. For example, the function manager 254 may process the portion of the function response from a first structured language into a second structured language (e.g., process the portion of the function response from a proprietary DSL into JSON), and the output message may be provided based on the portion in the second structured language. In some examples, the function manager 254 may process the portion of the function response in order to validate the grammar, structure and/or format of the structured language. The output message may be provided after the portion is validated.

Optionally, at an operation 516, a response summary may be added to the conversation history (e.g., added to the conversation history data object 262) to provide information about the function response. In some examples, the response summary may be text extracted from the function response itself. In some examples, the response summary may be a summary generated from the function response (e.g., using the summarizer 260 of the function manager 254, or using another language model).

Examples of the present disclosure enables more efficient execution of an LLM when the LLM makes a function call. Rather than having the LLM process a response from a called function, the function response can be selectively rerouted so that an output message based on the function response can be provided to a client device (e.g., via a UI) while bypassing the LLM. This avoids consumption of resources (e.g., tokens, compute resources, etc.) at the LLM to process a function response that it does not need to process (and might not process accurately). Further, this avoids the LLM inadvertently changing the formatting and/or structure of the function response and causing the function response to be unrenderable or unparseable by downstream processes.

It should be noted that bypassing the LLM in this way may not be trivial, as conventionally the LLM expects to receive a function response after a function call. Thus, rerouting the function response to bypass the LLM can result in poor operation of the LLM (e.g., subsequent messages generated by the LLM may continue to attempt the same function call) when implementation details are not well-considered. Examples disclosed herein enable a rerouting of a function response to bypass the LLM without negatively impacting the performance of the LLM and while improving the efficiency of the overall system.

In some examples, the function manager adds contextual information to the conversation history, without such contextual information needing to be processed by the LLM, for example by adding a response placeholder and/or summary that does not require involvement of the LLM. This ensures that the conversation history maintains an accurate representation of the ongoing conversation, including the result of calling the function, despite the function response bypassing the LLM. This helps to ensure that the LLM understands the current state of the ongoing conversation, thus maintaining the accuracy of the LLM's subsequently generated messages.

Although the present disclosure includes examples of transformer-based language models, it should be understood that the present disclosure may be applicable to any machine learning-based language model, including language models based on other neural network architectures such as recurrent neural network (RNN)-based language models or state space models (SSMs) (e.g., Hyena). Examples involving the use of an LLM is merely by way of example and the present disclosure is not necessarily so limited. For example, the techniques disclosed herein could potentially also be applied to other generative models such as, for example, other text generation models or multimedia models such as may serve to generate other forms of output or accept other forms of input beyond text (and which may, in some implementations, potentially include a generative text model along with one or more other models). In a specific example, a generative model (e.g., a multimedia model) that includes, amongst other types of models, an LLM in it, may be employed in association with the above-discussed techniques.

Although the present disclosure has described a LLM in various examples, it should be understood that the LLM may be any suitable language model (e.g., including LLMs such as LLaMA, Falcon 40B, GPT-3, or GPT-4, as well as other language models such as BART, among others).

Although the present disclosure describes methods and processes with operations (e.g., steps) in a certain order, one or more operations of the methods and processes may be omitted or altered as appropriate. One or more operations may take place in an order other than that in which they are described, as appropriate.

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

The scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. Any module, component, or device exemplified herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor readable storage media.

Memory, as used herein, may refer to memory that is persistent (e.g. read-only-memory (ROM) or a disk), or memory that is volatile (e.g. random access memory (RAM)). The memory may be distributed, e.g. a same memory may be distributed over one or more servers or locations.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A computer-implemented method comprising:
receiving, from a generative language model, a generated message based on an input message in an ongoing conversation, the generated message indicating a function call related to the input message;
cause execution of a function using the function call;
receiving a function response from the executed function; and
providing an output message to the ongoing conversation based on the function response, wherein the providing of the output message bypasses the generative language model.

2. The method of claim 1, wherein the function response bypasses the generative language model.

3. The method of claim 1, further comprising:
after receiving the function response, parsing the function response to identify at least a portion of the function response intended to bypass the generative language model, wherein the parsing is by a component other than the generative language model;
wherein the output message is provided based on at least the identified portion of the function response.

4. The method of claim 1, further comprising:
maintaining a conversation history for the ongoing conversation; and
adding a response placeholder to the conversation history to indicate receipt of the function response.

5. The method of claim 1, further comprising:
maintaining a conversation history for the ongoing conversation; and
adding a response summary to the conversation history, the response summary representing information contained in the function response.

6. The method of claim 5, wherein the response summary is extracted from the function response.

7. The method of claim 5, further comprising generating the response summary based on the function response.

8. The method of claim 1, wherein the function response includes a portion in a first structured language other than natural human language, and wherein the output message is provided based on the portion in the first structured language in the function response.

9. The method of claim 8, wherein the output message includes a copy of the portion in the first structured language in the function response.

10. The method of claim 8, wherein providing the output message comprises:
processing the portion in the first structured language into a corresponding portion in a second structured language; and
providing the output message using the portion in the second structured language.

11. The method of claim 8, wherein providing the output message comprises:
processing the portion in the first structured language to validate the portion in the first structured language; and
providing the output message based on the validated portion in the first structured language.

12. A computer system comprising:
at least one processor; and
a computer readable medium storing instructions that, when executed by the at least one processor, cause the computer system to:
receive, from a generative language model, a generated message based on an input message in an ongoing conversation, the generated message indicating a function call related to the input message;
cause execution of a function using the function call;
receive a function response from the executed function; and
provide an output message to the ongoing conversation based on the function response, wherein the output message is provided by bypassing the generative language model.

13. The computer system of claim 12, wherein the function response bypasses the generative language model.

14. The computer system of claim 12, wherein the instructions further cause the computer system to:
after receiving the function response, parse the function response to identify at least a portion of the function response intended to bypass the generative language model, wherein the parsing is by a component of the computer system other than the generative language model;
wherein the output message is provided based on at least the identified portion of the function response.

15. The computer system of claim 12, wherein the instructions further cause the computer system to:
maintain a conversation history for the ongoing conversation; and
add a response placeholder to the conversation history to indicate receipt of the function response.

16. The computer system of claim 12, wherein the instructions further cause the computer system to:
maintain a conversation history for the ongoing conversation; and
add a response summary to the conversation history, the response summary representing information contained in the function response.

17. The computer system of claim 12, wherein the function response includes a portion in a first structured language other than natural human language, and wherein the output message is provided based on the portion in the first structured language in the function response.

18. The computer system of claim 17, wherein the instructions further cause the computer system to provide the output message by:
processing the portion in the first structured language into a corresponding portion in a second structured language; and
providing the output message using the portion in the second structured language.

19. The computer system of claim 17, wherein the instructions further cause the computer system to provide the output message by:
processing the portion in the first structured language to validate the portion in the first structured language; and
providing the output message based on the validated portion in the first structured language.

20. A non-transitory computer-readable medium storing instructions that, when executed by at least one processor of a computer system, cause the computer system to:
receive, from a generative language model, a generated message based on an input message in an ongoing conversation, the generated message indicating a function call related to the input message;
cause execution of a function using the function call;
receive a function response from the executed function; and
provide an output message to the ongoing conversation based on the function response, wherein the output message is provided by bypassing the generative language model.
